(19) United States
(12) Patent Application Publication
(10) Pub. No.: US 2010/0127468 A1
(43) Pub. Date: May 27, 2010

(54) SKATEBOARD

(76) Inventor: Gyeonghui Park, Gwangju (KR)

Correspondence Address: MICHAEL TAVELLA, 2051 BRIGADIER DRIVE, ANCHORAGE, AK, 99507, US

(21) Appl. No.: 12/451,929

(22) PCT Filed: Jun. 17, 2008
(86) PCT No.: PCT/KR2008/003423

§ 371 Date: Dec. 7, 2009

(30) Foreign Application Priority Data
Jun. 19, 2007 (KR) 10-2007-0059714
Jun. 19, 2007 (KR) 10-2007-0059795
Oct. 27, 2007 (KR) 10-2007-0105854

(51) Int. Cl. B62M 1/00

(52) U.S. Cl. 280/87.042

(57) ABSTRACT

The present invention relates to a skateboard, and more particularly, to a skateboard that can freely turn with a very short turning radius and can be self-propelled by a user without direct contact to the ground.

### TECHNICAL FIELD

The present invention relates to a skateboard, and more particularly, to a skateboard that can freely turn with a very short turning radius and can be self-propelled by a user without direct contact to the ground.

### BACKGROUND ART

Conventional skateboards are disclosed in the registered Korean Patent Publications No. 10-0394848 titled “Skateboard having a direction-caster” or No. 10-0612427. In the above skateboards, front and rear plates are coupled by a connection member that is bendable and elastically restorable. The front and rear plates include direction casters on bottoms thereof wherein the direction casters can be turned toward the direction in which the plates are inclined. Accordingly, a turning radius of the skateboard can be minimized and function of the direction casters can be maximally utilized by independently steering front and rear wheels of the front and rear plates.

### DISCLOSURE OF INVENTION

### Technical Problem

However, when the front and rear plates are separately provided and connected to each other in a spaced state in the above conventional skateboards, there has been problems as below.

Total available area of the plate is reduced and thus the space for the user's feet becomes narrow. Accordingly, the user cannot play various riding skills that are unique in the skateboards.

Particularly, the user cannot use the middle portion of the skateboard and thus cannot place his/her foot on the middle portion. Accordingly, the user cannot play the grinding skill (skill of sliding a corner of an object using right or left edges of the skateboard) that can be played by conventional classical skateboard.

In addition, in the case where the space between the front and rear plates is narrow, there is caused a safety problem that a portion of the user's body may be caught in the space when the front and rear plates are bent oppositely to each other.

### Technical Solution

Accordingly, an object of the present invention is to provide a skateboard, which includes: a diagonally bendable rectangular plate whose middle portion is not bent; and a member provided at right and left edges of the plate, where the member cannot be vertically bent.

### Advantageous Effects

The skateboard according to the present invention produces following effects.

The plate of the skateboard is formed of a single plate without being divided into the front and rear plates and the middle portion of the plate is not folded or bent. Thus, the user can utilize the entire plate as a foothold and run using side edges of the skateboard with a very short turning radius and propel the skateboard by the user without being contacted to the ground.

In addition, the skateboard can maintain the shape of single plate as the same as the classical skateboard. Accordingly, the user can easily keep balance by stepping on the skateboard with oppositely inclined both feet.

### BRIEF DESCRIPTION OF THE DRAWINGS

FIG. 1 is a view illustrating front, side and bottom;

FIG. 2 is a plan view illustrating only a plate 10 without a driving wheel, where section boundaries C1 and C2, and wheel fixing parts 20P are shown as dotted lines, the section boundaries C1 and C2 being formed when the plate is diagonally bent;

FIG. 3 is a side view illustrating diagonal bending operation of the plate;

FIG. 4 is a exemplary view illustrating various examples of a support unit 30, where “A” shows the support unit provided on the bottom and “B” shows the support unit provided on the upper surface and “C” shows the support unit provided at edges and “D” shows the support unit inserted into the edges and “E” shows the support unit formed by extending the edges vertically and “F” shows the support unit formed by thickening the edges;

FIG. 5 shows plates according to another embodiment of the present invention, where “A” and “B” are bottom views;

FIG. 6 is a view illustrating front and bottom;

FIG. 7 is a view illustrating the front and bottom of the plate;

FIG. 8 is a view illustrating the plate provided with a reinforcing support unit (EF), where “A” is a bottom view and “B” is a perspective bottom view;

FIG. 9 is a bottom view of the plate;

FIG. 10 is a view illustrating front, side and bottom;

FIG. 11 is a side view illustrating diagonal bending operation of the plate;

FIG. 12 is a exemplary view illustrating various examples of a bending portion 40, where “A” shows the bending portion formed by a groove (U) concaved in the plate before and after the plate is diagonally bent and “B” shows the bending portion formed by dividing the plate along a section boundary and coupling the divided plates by a bending portion [symbol] (T) and “C” shows the bending portion formed by a groove (H) perforated in the plate;

FIG. 13 is a plan view illustrating a plate provided with the bending portion of “C” of FIG. 12;

FIG. 14 is a view illustrating side and bottom of a wheel 20 according to one embodiment; and

FIG. 15 is a front view illustrating turning operations of the wheel when the wheel of FIG. 14 is mounted on the bottom of the plate and the plate is diagonally bent, where “A” shows operation of a front wheel and “B” shows operation of a rear wheel through cutting the middle portion of the plate.

### BEST MODE FOR CARRYING OUT THE INVENTION

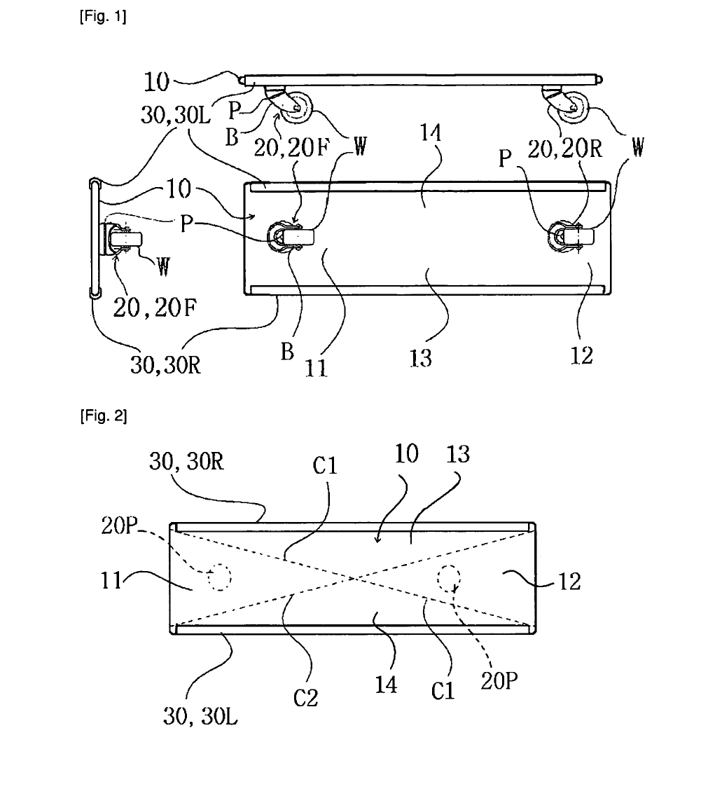

Referring to FIGS. 1 to 3, a skateboard according to one embodiment of the present invention includes: a plate 10 that can be divided into a first side 11, a second side 12, a third side 13 and a fourth side 14 along section boundaries C1 and C2 formed when the plate is diagonally bent; a supporting unit 30 (30L, 30R) provided at the third and fourth sides 13 and 14 of the plate 10 in order to prevent them from being bent; and a wheel unit 20 having driving wheels (W) provided at the first and second sides 11 and 12 of the plate 10.

It is desirable that the plate 10 is made of elastic material such as bendable flexible, thermoplastic or elastic rubber, metal, synthetic resin, PE which has strength to endure load of a user and can be easily elastically restored after the first and second sides 11 and 12 are diagonally bent so as to cross each other.

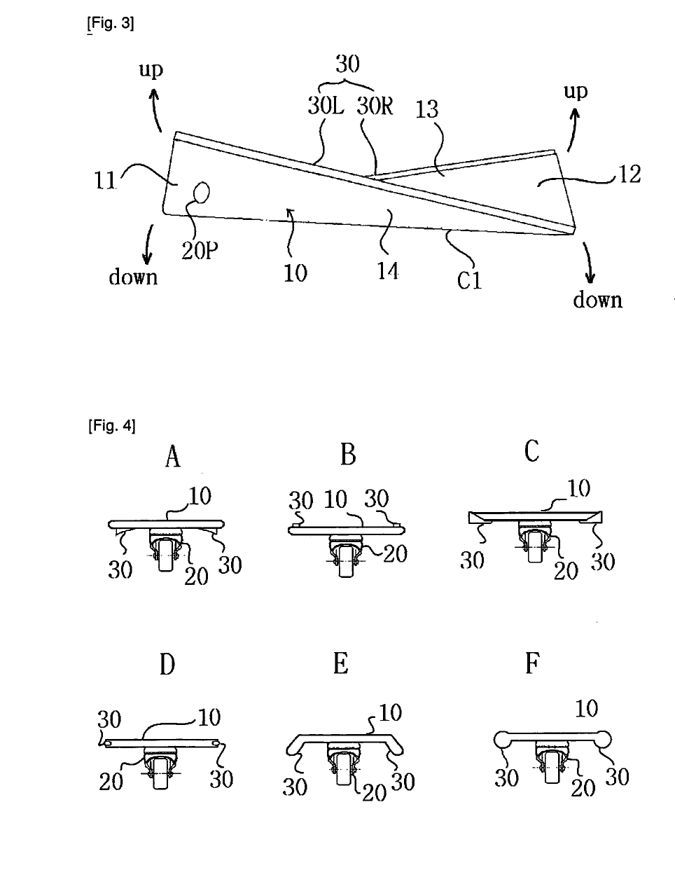

The first and fourth sides 11 and 14 form a triangle shape. As shown in FIG. 3, the first and fourth sides 11 and 14 are paired with each other and the second and third sides 12 and 13 are paired with each other according to the bending direction. The first and fourth sides 11 and 14 and second and third sides 12 and 13 can be bent along the section boundary C1 between them. When the plate is bent oppositely to the above bending direction, the first and third sides 11 and 13 are paired with each other and the second and fourth sides 12 and 14 are paired with each other. The first and third sides 11 and 13 and second and fourth sides 12 and 14 can be bent along the section boundary C2 between them.

Accordingly, the first and second sides 11 and 12 of the plate 10 can be inclined to the left or right according to the bending direction.

On the other hand, the middle portion of the plate 10 may be bent by the load of the user. To solve the problem, the supporting unit 30 (30L, 30R) are provided at the third and fourth sides 13 and 14 of the plate 10 in order to prevent the middle portion from being bent.

The supporting unit 30 may be a supporting shaft made of metal or synthetic resin that is formed or coupled along a length of the plate 10 or a supporting plate that is additionally attached to the surface of the plate 10.

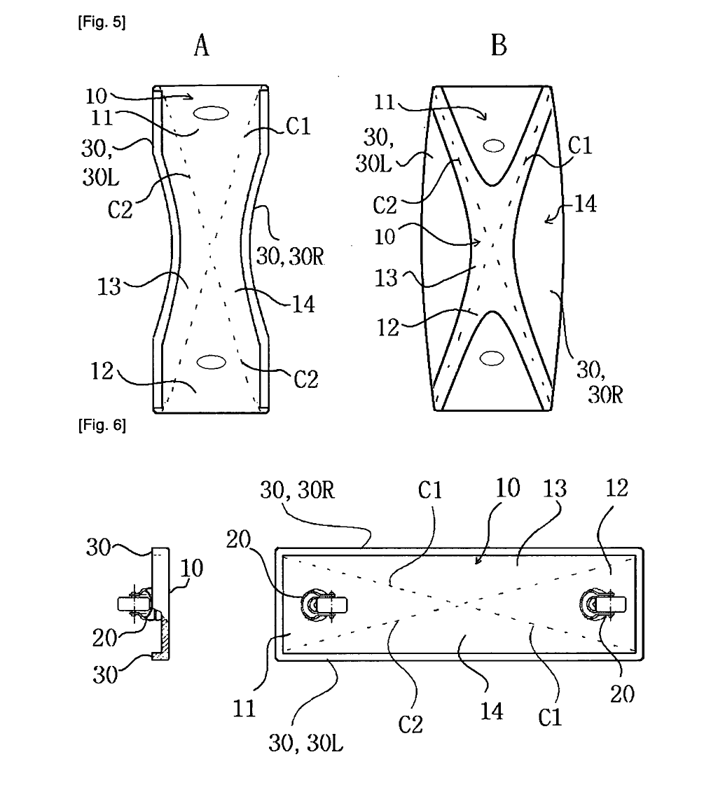

Referring to FIGS. 2 and 5A, the supporting shaft is attached to edges of the third and fourth sides 13 and 14 in a shape of rod. In addition, referring to FIGS. 4A and 4D, the supporting shaft is additionally attached. FIGS. 4E and 4F show supporting shafts formed by vertically folding, projecting or thickening the edges of the plate 10. Of course, the supporting shaft may not be provided at the outermost edge but provided near the middle of the plate 10 within the range in which the middle portion of the plate is not bent.

The supporting plate may be additionally attached to the third and fourth sides 13 and 14 of the plate 10 as shown in FIG. 5B. In addition, the supporting plate may be attached to the first and second sides 11 and 12 in order to help the plate to bear the load of the user better.

On the other hand, the supporting shaft may be also additionally provided at the first and second sides 11 and 12.

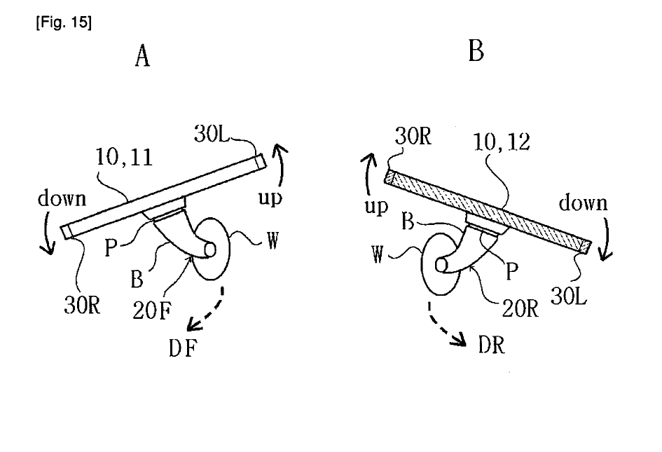

The wheel unit 20 may include at least one caster wheel that can turn according to inclination of the plate 10. Particularly, as shown in FIG. 14, the caster may be a direction-caster whose bracket (B) is pivoted (P) to a 20P fixing the wheel unit 20 on the bottom of the plate 10 with a wedge angle (A) to a running direction. In addition, the wheel unit 20 may include a truck instead of the caster wherein the truck is a driving unit used in the conventional skateboard. In addition, the driving unit may be formed by properly combining the caster, truck or fixed wheel set to each other.

Referring to FIG. 15, the direction-caster is turned in proportional to horizontal inclination of the plate 10 to generate driving force. FIG. 15A shows the turning operation (DF) of a front wheel 20F of the wheel unit 20 according to inclination of the plate 10 and FIG. 15B shows the turning operation (DR) of a rear wheel 20R of the wheel unit 20.

As described above, the skateboard can be steered with a very short turning radius and can generate driving force.

### Mode for the Invention

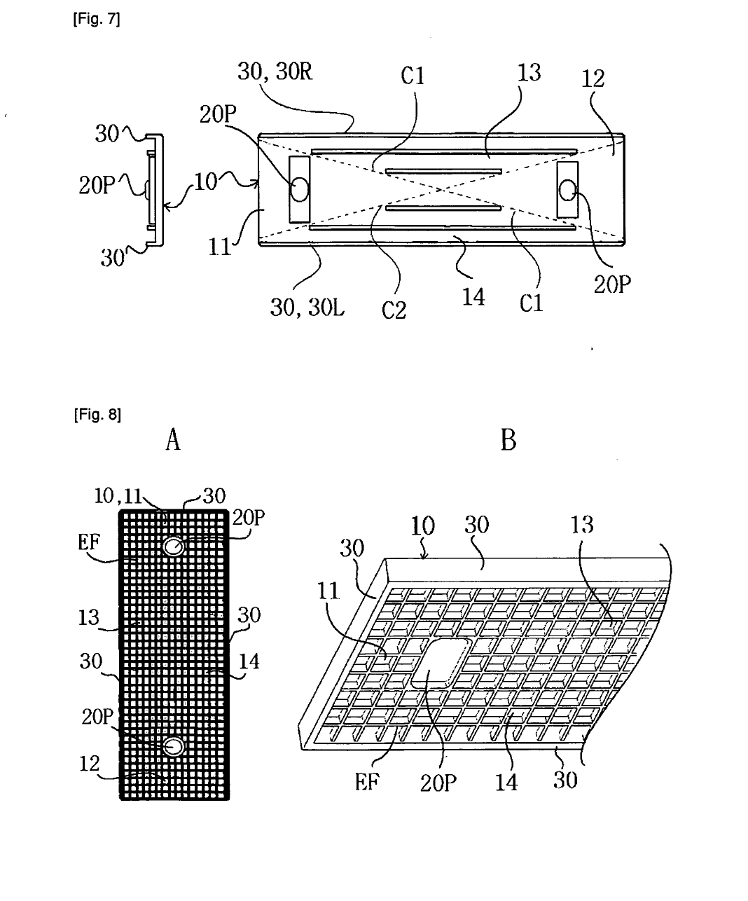

FIGS. 6 to 9 show various embodiments of the supporting unit 30.

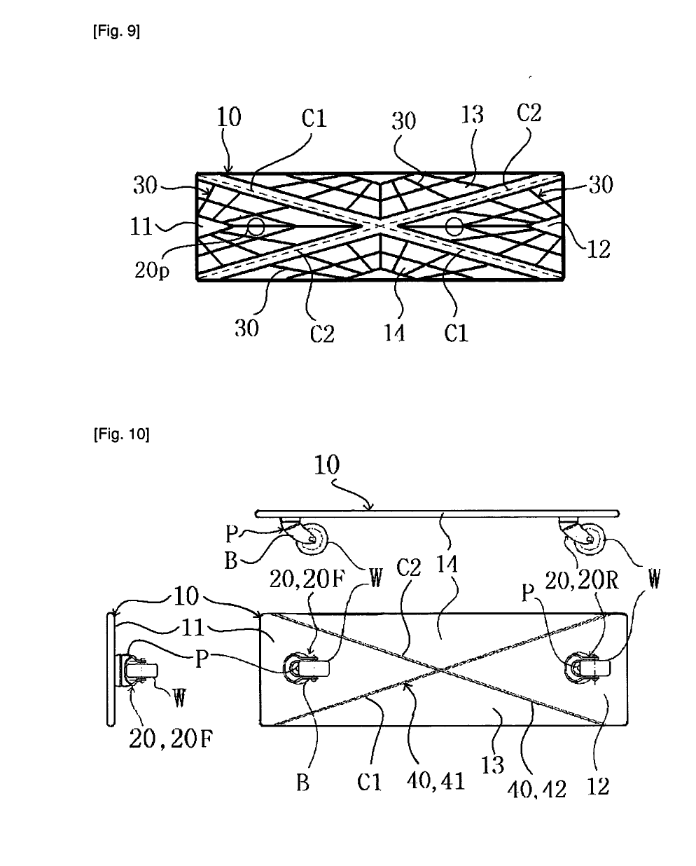

Referring to FIG. 6, the supporting shaft is formed by vertically folding or projecting the first to fourth edges of the plate. The plate cannot be bent in other directions except that the plate is diagonally bent along the section boundaries C1 and C2. Referring to FIG. 7, a plurality of supporting shafts used in the supporting unit 30 are formed to bear heavy load. Referring to FIG. 8, a reinforcing support unit (EF) is projected vertically from the entire plate so as to bear heavy load. Referring to FIG. 9, the supporting shaft or reinforcing support units are formed on the plate except for the section boundaries C1 and C2.

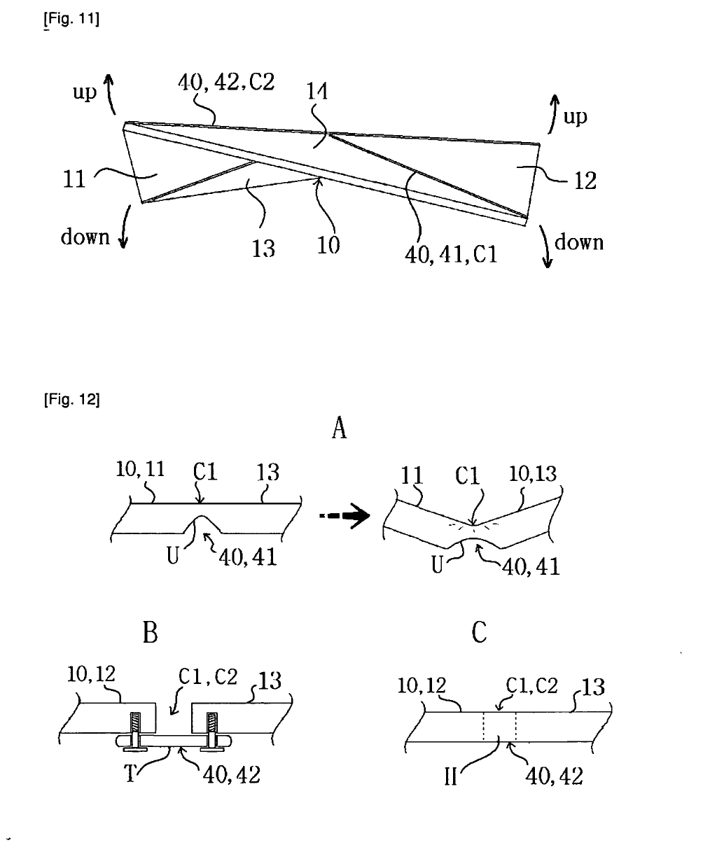

The plates 10 shown in FIGS. 10, 11 and 12B are hard or not easily bent. The plate 10 is divided into segments such as a first side 11, a second side 12, a third side 13 and fourth side 14 and the section boundaries C1 and C2 between the segments are coupled by bending portion 40 (41, 42). A bendable member (T) such as rubber or metal is used as the bending portion 40. It is more desirable that the bending portion is elastically restorable.

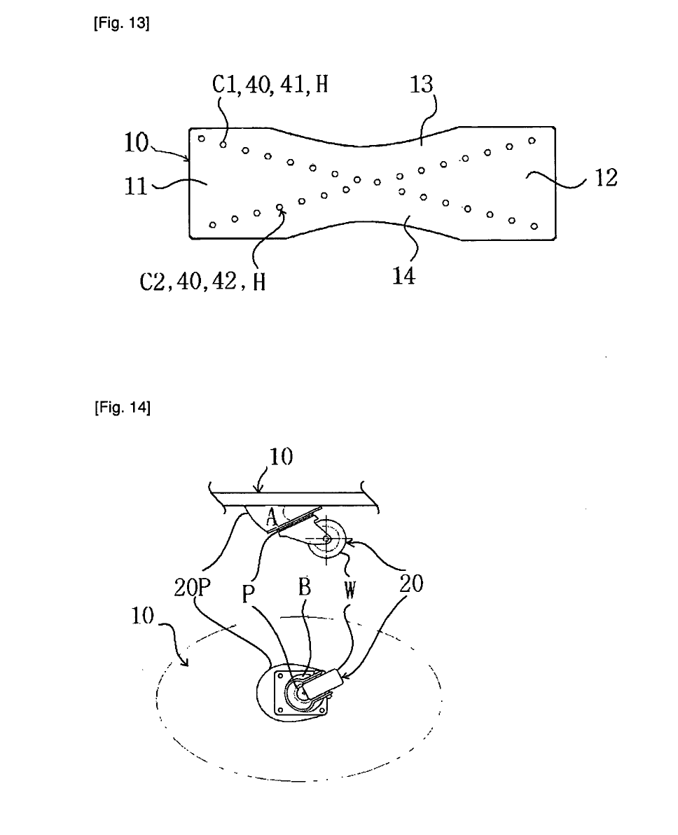

As shown in FIGS. 12A, 12C and 13, the plate 10 itself is not easily bent but bendable through the bending portion 40 formed by a concaved groove (U) or perforated groove (H).

### INDUSTRIAL APPLICABILITY

The skateboard of the present invention can be used in wheel reports fields such as play, performance and driving using the same.

1. A skateboard, comprising:
a plate 10 that can be divided into a first side 11, a second side 12, a third side 13 and a fourth side 14 along section boundaries C1 and C2 formed when the plate is diagonally bent;
a supporting unit 30 provided at the third and fourth sides 13 and 14 of the plate 10 in order to prevent them from being bent; and
a driving wheel unit 20 provided at the first and second sides 11 and 12 of the plate 10.

2. A skateboard, comprising:
a plate 10 that is divided into a first side 11, a second side 12, a third side 13 and a fourth side 14 by section boundaries C1 and C2 formed by a bending portion 40, where the plate can be diagonally bent along section boundaries C1 and C2; and
a driving wheel unit 20 provided at the first and second sides 11 and 12 of the plate 10.

3. The skateboard of claim 1, wherein the supporting unit 30 is a supporting shaft formed or coupled along a length of the plate 10.

4. The skateboard of claim 1, wherein the supporting unit 30 is a supporting plate additionally attached to the surface of the plate 10.

5. The skateboard of claim 2, wherein the bending portion 40 is formed by a groove concaved or perforated in the plate 10.

6. The skateboard of claim 2, wherein the first, second, third and fourth sides 11, 12, 13 and 14 are separated from each other and the bending portion 40 is a bending member to couple section boundaries between them.

7. The skateboard of any one of claims 1 to 6, wherein the driving wheel unit 20 comprises at least one a direction-caster that turns according to inclination of the plate 10.
